(19) United States
(12) Patent Application Publication
(10) Pub. No.: US 2006/0150224 A1
(43) Pub. Date: Jul. 6, 2006

(54) Video streaming

(76) Inventor: Othon Kamariotis, Athens (GR)

Correspondence Address: NIXON & VANDERHYE, PC, 901 NORTH GLEBE ROAD, 11TH FLOOR, ARLINGTON, VA, 22203, US

(21) Appl. No.: 10/539,414

(22) PCT Filed: Dec. 30, 2003
(86) PCT No.: PCT/GB03/05643

§ 371 Date: Jun. 17, 2005

(30) Foreign Application Priority Data
Dec. 31, 2002 (GB) 0230328.7

(51) Int. Cl. H04N 7/173

(52) U.S. Cl. 725/89; 725/90

(57) ABSTRACT

A file server (1) in communication with a remote client (e.g. PPC 7, Mobile phone client 5) receives images from a camera (2) or video store (4) as full frame images. A selection and compression programme enable the transmission of bit streams defining a compressed video image for display on the comparatively small screen of the mobile client and permits simple virtual zoom and frame area selection to be viewed by the user. Compression and selection algorithms enable the user to select an angle view having a corresponding number of pixels to the local screen but derived from the whole of the original frame and fully compressed and with varying selections of compression between down to selection by the file server (1) of a portion of the original frame having the same number of pixels. The system may find use particularly where bandwidth between the client and the file server is limited so that it is unnecessary for the whole of the video frame to be transmitted to the client and only limited return signalling from the client to the server is required.

The present invention relates to video streaming and more particularly to methods and apparatus for controlling video streaming to permit selection of viewed images remotely.

It is known to capture video images using digital cameras for such things as security whereby a camera may be used to view an area, then signal being transmitted to a remote location or stored in a computer storage medium. Several cameras are often used to ensure a reasonable resolution of the are being viewed and zoom facilities enable real-time close up images to be captured. Different viewing angles may be provided co-temporaneously to enable the same scene to be viewed from differing angles.

It is also known to store film sequences in a computer store for downloading to a television screen or other display device over a high bandwidth link and/or to provide video compression, for example as provided by MPEG coding, to allow images to be transferred over lower bandwidth interconnections in real time or near real time.

Smaller display devices such as pocket personal computers, such as Hewlett Packard PPCs or Compaq IPAQ computers also have relatively high resolution display screens which are in practice relatively small for most film or camera images covering surveillance areas for example.

Even smaller viewing screens are likely to be provided on compact mobile phones for example Sony Ericsson T68i mobile phones which include sophisticated reception and processing capabilities allowing colour images to be received and displayed by way of mobile phone networks.

Recent developments in home television viewing such as the ability to store and read digital data held on Digital Versatile Discs (DVD) has led to the ability of the viewer to select varying camera angles from which to view a scene and to select a close-up view of particular areas of the scene depicted. Players for DVD include the processing capability for carrying out the adaptation of the stored data and conversion in to signals for the picture to be displayed.

Such data to signal conversions require significant real-time processing power if the viewers experience is not to be detracted from. Additionally, very large amounts of data needs to be encoded and stored locally to enable the processing to take place.

Where limited transmission bandwidth is available together with a limited size of screen display such abilities as zooming in to the area of screen to be viewed, reviewing differing viewing angles and the like are not practical because of the amount of data required to be transferred to the local device.

In EP1162810 there is described a data distribution device which is arranged to convert data held in a file server, which may be holding camera derived images. The device is arranged to convert data received or stored into a format capable of being displayed on a requesting data terminal which may be a cellular phone display. The conversion device therein has the ability to divide a stored or received image into a number of fixed sections whereby signals received from the display device can be used to select a particular one of the available image sections.

According to the present invention there is provided a method of streaming video signals comprising the steps of capturing and/or storing a video frame or a series of video frames each frame comprising a matrix of “m” pixels by “n” pixels, compressing the or each said m by n frame to a respective derived frame of “p” pixels by “q” pixels, where p and q are respectively substantially less than m and n, for display on a screen capable of displaying a frame of at least p pixels by q pixels, transmitting the at least one derived frame and receiving signals defining a preferred selected viewing area of less than m by n pixels, compressing the selected viewing area to a further derived frame or series of further derived frames of p pixels by q pixels and transmitting the further derived frames for display characterised in that the received signals include data defining a preferred location within the transmitted further derived frame which determines the location within the m pixel by n pixel frame from which the next further derived frame is selected.

Preferably received signals may also define a zoom level comprising a selection of one from a plurality of offered effective zoom levels each selection defining a frame comprising at least p pixels by q pixels but not more than m pixels by n pixels.

Received signals may be used to cause movement of the transmitted frame from a current position to a new position on a pixel by pixel basis or on a frame area selection basis. Alternatively automated frame selection may be used by detecting an area of apparent activity within the major frame and transmitting a smaller frame surrounding that area.

Control signals may be used to select one of a plurality of pre-determined frame sizes and/or viewing angles. In a preferred embodiment control signals may be used to move from a current position to a new position within the major frame and to change the size of the viewed area whereby detailed examination of a specific area of the major frame may be achieved. Such a selection may be by means of a jump function responsive to control functions to select a different frame area within the major frame in dependence upon the location of a pointer or by scrolling on a pixel by pixel basis.

Terminal apparatus for use with such a system may include a first display screen for displaying transmitted frames and a second display screen having selectable points to indicate the area being displayed or the area desired to be displayed and transmission means for transmitting signals defining a preferred position within a currently displayed frame from which the next transmitted frame should be derived.

Such a terminal may also include a further display means including the capability to display the co-ordinates of a current viewing frame and/or for displaying text or other information relating to the viewing frame. The text displayed may be in the form of a URL or similar identity for a location at which information defining viewing frames is stored.

Control transmissions may be by way of a low bandwidth path with a higher bandwidth return path transmitting the selected viewing frame. Any suitable transmission protocols may be used.

A server for use in the invention may comprise a computer or file server having access to a plurality of video stores and/or connection to a camera for capturing images to be transmitted. A digital image store may also be provided in which images captured by the camera may be stored so that movement through the viewed area may be performed by the user at a specific instant in time if live action viewing indicates a view of interest potentially beyond or partially beyond a current viewing frame.

The server may run a plurality of instances of a selection and compression program to enable multiple transmissions to different users to occur. Each such instance may be providing a selection from a camera source or stored images from one of said video stores.

In one operational mode the program instance causes the digitised image from camera or video store to be pre-selected and divided in to a plurality of frames each of which is simultaneously available to switch means responsive to customer data input to select which of said frames is to be transmitted. The selected digitised image then passes through a codec to provide a packaged bit stream for transmission to the requesting customer.

In an alternative mode of operation, each of the plurality of frames is converted to a respective bit stream ready for transmission to a requesting customer a switch selecting, in response to customer data input, the one of the bit streams to be transmitted.

Where the customer is selecting a part frame to be viewed from a major frame, the server responds to a customer data packet requesting a transmission by transmitting a compressed version of the major frame or a pre-selected area from the major frame and responds to customer data signals defining a preferred location of viewing frame to cause transmission of a bit stream defining a viewing frame at the preferred location wherein the server is responsive to data signals defining a preferred location within an earlier transmitted frame to select the location within the m by n major frame from which the next p by q derived frame is transmitted.

Apparatus and methods for performing the invention will now be described by way of example only with reference to the accompanying drawings of which:

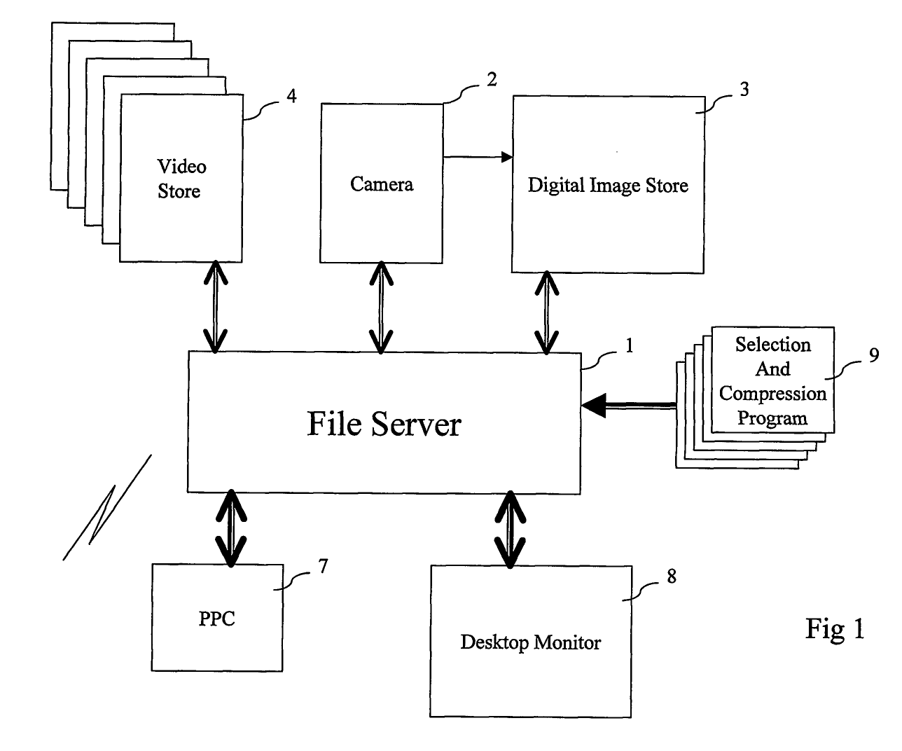

FIG. 1 is a block schematic diagram of a video streaming system in accordance with the invention;

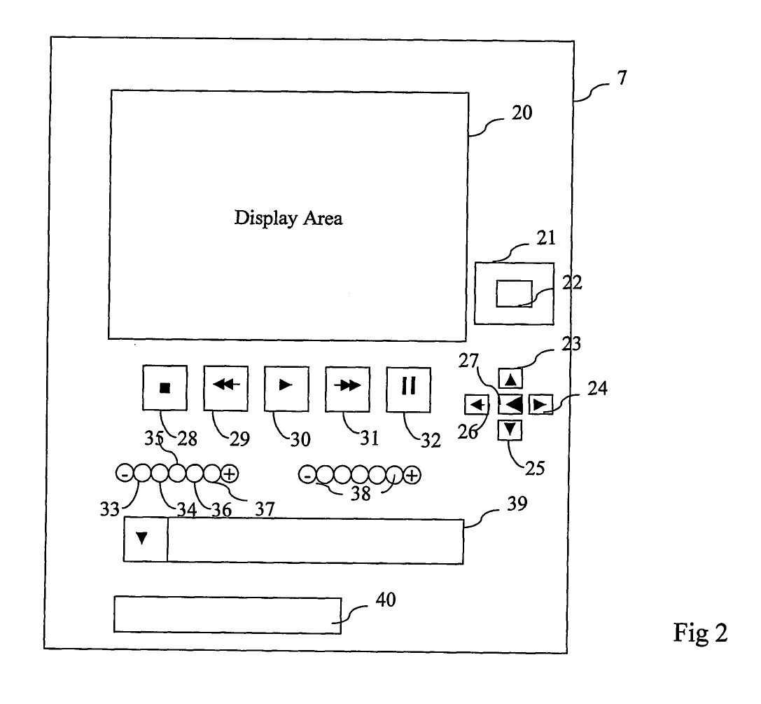

FIG. 2 is a schematic diagram of an adapted PDA for use with the system of FIG. 1;

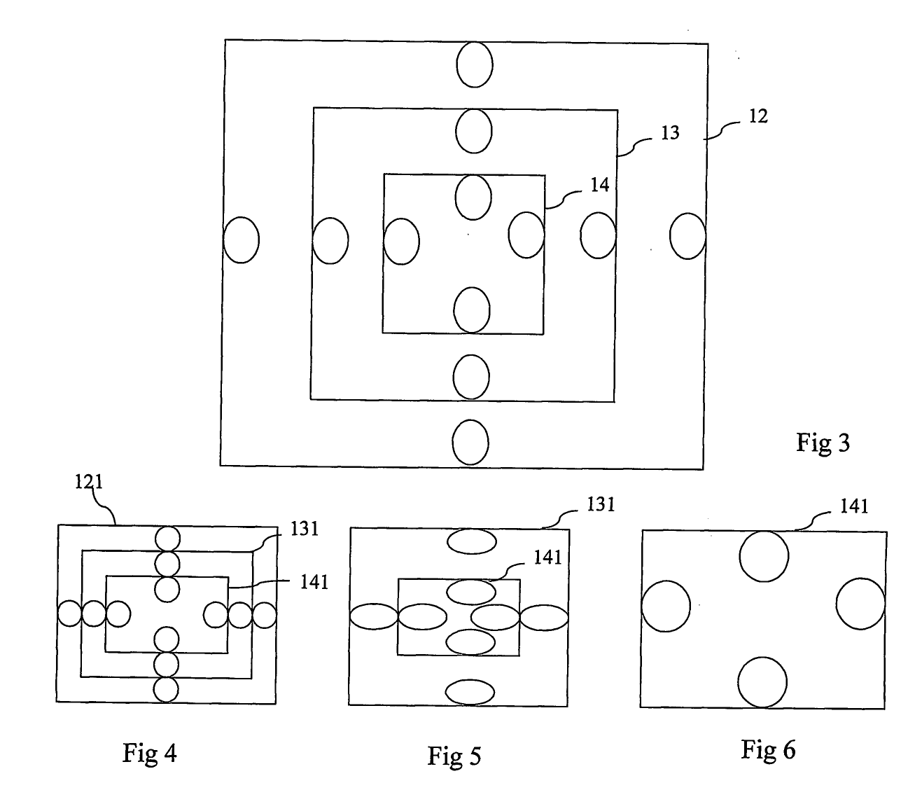

FIG. 3 is a schematic diagram of a field of view frame (major frame) from a video streaming source or video capture device;

FIGS. 4, 5 and 6 are schematic diagrams of field of view frames derived from the major frame as displayed on viewing screen at differing compression ratios;

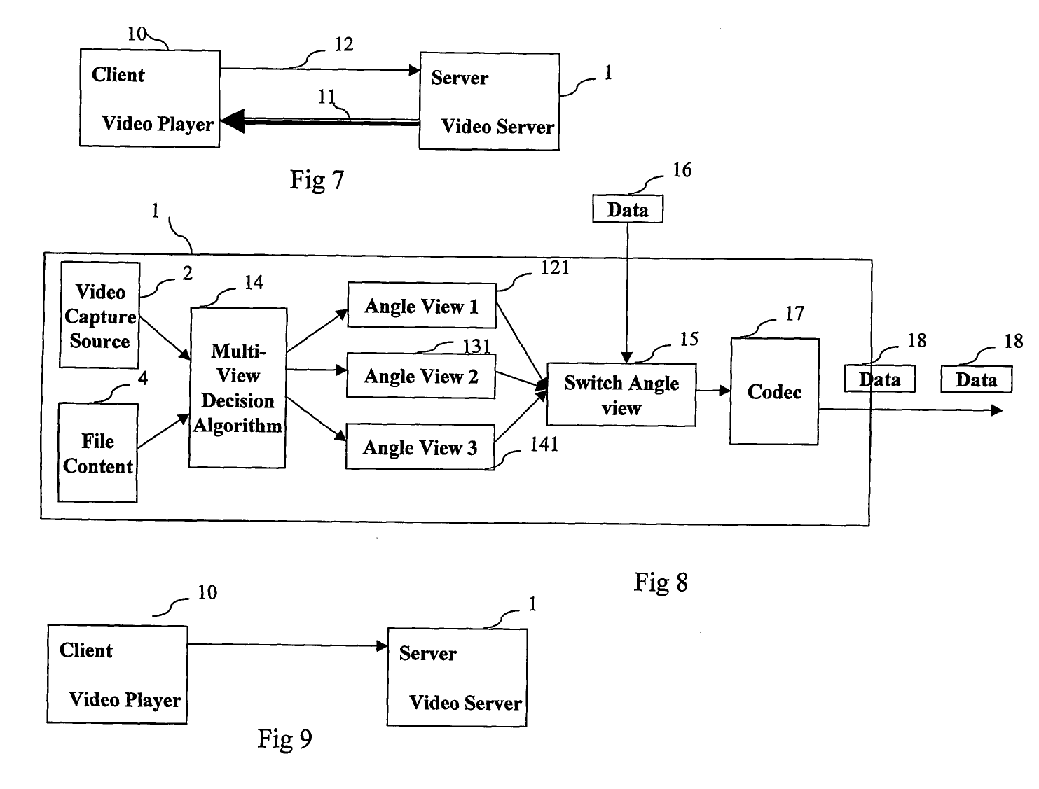

FIG. 7 is a schematic diagram of transmissions between a viewing terminal and the server of FIG. 1;

FIG. 8 is a schematic diagram showing the derivation of viewing frames and the selection of a viewing frame for transmission;

FIG. 9 is a schematic diagram which shows an alternative transmission arrangement to that of FIG. 7;

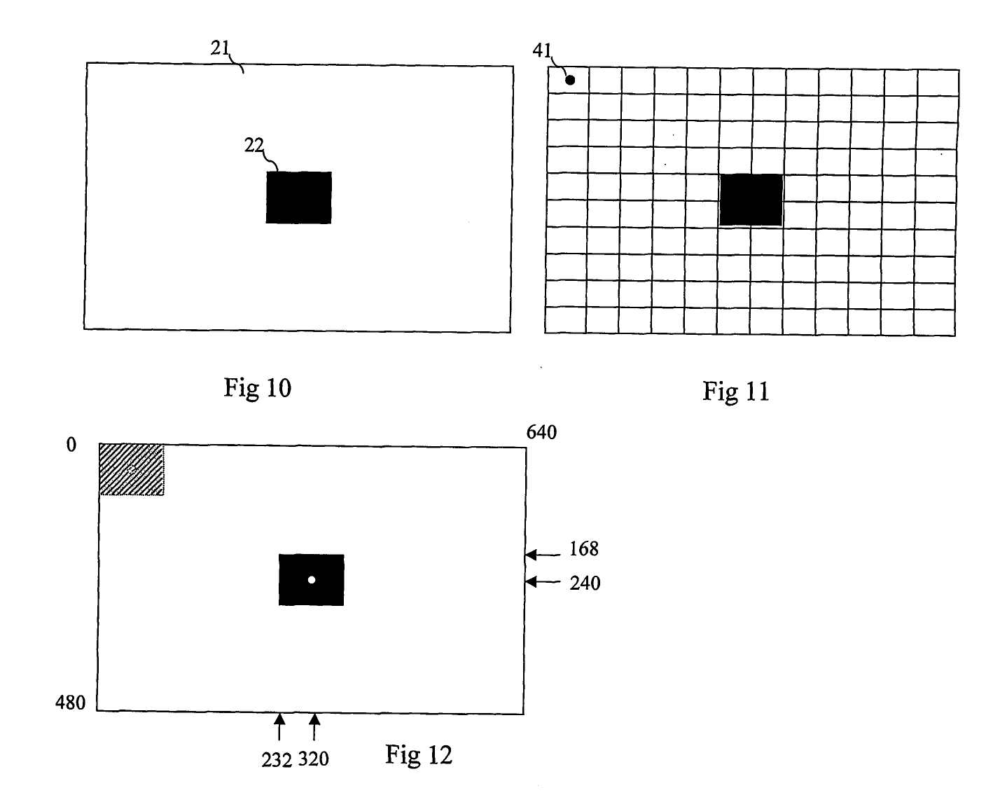

FIGS. 10, 11 and 12 are schematic diagrams showing the selection of areas of a major frame for transmission;

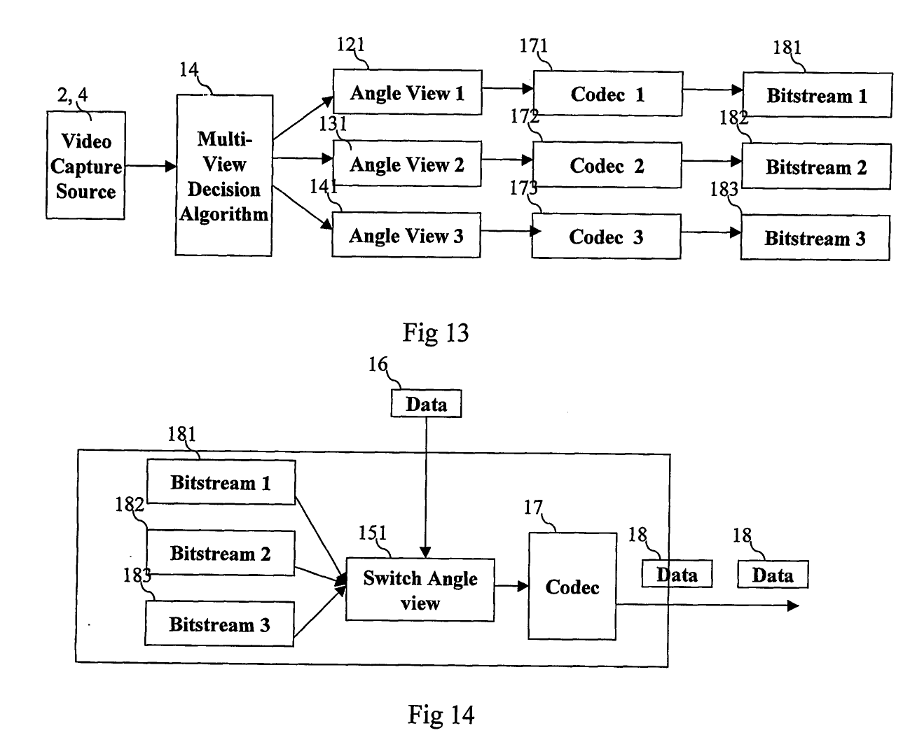

FIG. 13 is a schematic diagram showing an alternative derivation to that of FIG. 8; and

FIG. 14 shows the selection of a bit stream output of FIG. 13 for transmission.

Referring first to FIG. 1, the system comprises a server 1 for example a suitable computer, at least one camera 2 having a wide field of vision and a digital image store 3. In addition to the camera a number of video storage devices 4 may be provided for storing previously captured images, movies and the like for the purpose of distribution to clients represented by a cellular mobile phone 5 having a viewing screen 6, a person pocket computer (PPC) 7 and a desk top monitor 8. Each of the communicating devices 5. 7, 8 is capable of displaying images captured by the camera 2 or from the video storage devices 4 but only if the images are first compressed to a level corresponding to the number of pixels in each of the horizontal and vertical directions of the respective viewing screens.

It is anticipated that the camera 2 (for example a . . . which has a high pixel density and captures wide area images at . . . pixels by . . . pixels) will be capable of resolving images to a significantly higher level than can be viewed in detail on the viewing screens. Thus the server 1 runs a number of instances of a compression program represented by program icons 9, each program serving at least one viewing customer and functioning as hereinafter described.

In order to describe the architecture, it will be assumed that the video capture source is a camera 2 with a maximum resolution of 640×480 pixels. It will however be realised that the video capture source could be of any kind (video capture card, uncompressed file stream and the like capable of providing digitised data defining images for transmission or storage) and the maximum resolution could be of any size too (limited only by the resolution limitations of the video capture source).

Additionally, we will make the assumption that the video server is compressing and streaming video with a “fixed” frame size (resolution) 176×144 pixels, which is always less or equal to the original capture frame size. It will again be realised that, this “fixed” video frame size could be of any kind (dependent on the video display of the communications receiver) and may be variable provided that the respective program 9 is adapted to provide images for the device 5,7,8 with which its transmissions are associated.

An algorithm, hereinafter described is used to determine the possible angle-views available. Other algorithms could be used to determine the potential “angle-views”.

Referring briefly to FIG. 7, a first client server interaction architecture is schematically shown including the server 1 and a client viewer terminal 10 which corresponds to one of the viewing screens 6,7 of FIG. 1. In the forward direction (from the Server 1 to the Client 10) data transmission using a suitable protocol reflecting the bandwidth of the communications link 11 is used to provide a packetised data stream, containing the display information and control information as appropriate. The link may be for example a cellular communications link to a cellular phone or Personal Digital Organiser (PDA) or a Pocket Personal Computer (PPC) or maybe a higher bandwidth link such as by way of the internet or an optical fibre or copper landline. The protocol used may be TCP, UDP, RTP or any other suitable protocol to enable the information to be satisfactorily carried over the link 11.

In the backward direction (from the client 10 to the server 1) a narrower band link 12 can be used since in general this will carry only limited data reflecting input at the client terminal 10 requesting a particular angle view or defining a co-ordinate about which the client 10 wishes to view.

Turning now to FIG. 3, the image captured (or stored) comprises a 640 by 840 pixel image represented by the rectangle 12. The rectangle 14 represents a 176 by 144 pixel area which is the expected display capability of a client viewing screen 10 whilst the rectangle 13 encompasses a 352 by 288 pixel view.

Referring also to FIG. 4, the view of rectangle 12 may be reproduced following compression to 176 by 144 pixels schematically represented by rectangle 121. It will be seen from the representation that the viewed image will contain all of the information in the captured image. However, the image is likely to be “fuzzy” or unclear and lacking detail because of the compression carried out. This view may however be transmitted to the client terminal 10 in the first instance to enable the client to determine the preferred view on the client terminal display This may be done by defining rectangle 121 as “angle view 1”, the smaller area 13 (rectangle 131) as angle view 2 and the screen size corresponding selection 14 (rectangle 141) as angle view 3 enabling a simple entry from a keypad for example of digits one, two or three to select the view to be transmitted. This allows the viewer to select a zoom level which is effected as a virtual zoom within the server 1 rather than being a physical zoom of the camera 1 or other image capture device.

Thus if the client selects angle view 2, the image may appear similar to that of FIG. 5 having slightly more detail available (although some distortion may occur due to any incompatibility between the x and y axes of the captured image to the viewed image area). The client may again choose to zoom in further to view the area encompassed by rectangle 141 to obtain the view of FIG. 6 which is directly selected on a pixel correspondent basis from the captured image.

While the description above shows the provision of three angle views it should be appreciated that the number of views which can be derived from the captured image 12 is not so limited and a wider selection of potential views is easily generated within the server 1 to provide the client 10 with a wider choice of viewing angles and zoom levels from which to select.

It is also noted that the numeric information returned from the client terminal 10 need not be as a result of a displayed image but could be a pre-emptive entry from the client terminal 10 on the basis of prior knowledge by the user of the views available. In an alternative implementation, the server may select the initially transmitted view on the basis of the user's historic profile so that the user's normally preferred view is initially transmitted and users response to the transmission determines any change in zoom level or angle view subsequently transmitted.

The algorithm used to provide the potential angle views is simple and uses the following steps:—

The maximum resolution of the capture source (e.g. camera 1) is required, in this example 640 by 480 pixels). The resolution of the compressed video stream is also required, herein assumed to be 176 by 144 pixels).

For the first calculated angle view a one-to-one relationship directly from the captured video stream is used. Thus referring also to FIG. 3, pixels within the window 14 are directly used to provide a 176 by 144 pixel view (angle view 3, FIG. 6).

To calculate the dimensions of the next angle view each of the x and y dimensions is multiplied by 2 giving 352 by 488 pixels as the next recommended angle view. The server is programmed to check that the application of the multiplier does not exceed the selection to exceed the dimensions of the video stream from the capture source (640 by 480) which in this step is true.

In the next step the dimensions of the smallest window 14 are multiplied by three, provided that the previous multiplier did not cause either for the x and y dimensions to exceed the dimensions of the captured view. In the demonstrated case this multiplier results in a window of 528 by 432 pixels (not shown) which would be a further selectable virtual zoom.

The incremental multiplication of the x and y dimensions of the smallest window 14 continues until one of the dimensions exceeds the dimensions of the video capture window whereupon the process ceases and determines this multiplicand as angle view 1, the other zoom factors being defined by incremental angle view definitions. Thus the number of angle views having been determined and the possible angle views are produced the number of available angle views is transmitted by the server 1 to the client 10. One of these views will be a default view for the client, which may be the fully compressed view (angle view 1, FIG. 4) or, as hereinbefore mentioned a preference from a known user or by pre selection in the server.

The client terminal will display the available angle views at the client viewing terminal 10 to enable the user to decide which view to pick. Once the client has determined the required view data defining that selection is transmitted to the server 1 which then transmits the respective video stream with the remotely selected angle view.

Thus turning now to FIG. 8, the server 1 takes information from the video capture source, for example the camera 2, digital image store 3 or video stores 4, and applies the multi view decision algorithm (14) hereinbefore described. This produces the selected number of angle views (three are shown) 121, 131, 141 which are fed to a digital switch 15. The switch 15 is responsive to incoming data packets 16 containing angle view decisions from the client (for example the PPC 6 of FIG. 1) to stream the appropriate angle view data to a codec 17 and thence to stream the compressed video in data packets 18.

For the avoidance of doubt it is noted that the codec 17 may use any suitable coding such as MPEG4, H26L and the like, the angle views produced being completely independent of the video compression standard being applied.

In FIG. 9 there is shown an alternative client server interaction in which only 1 way interaction occurs. Network messages are transmitted only from the client to the server to take account of bandwidth limitations, the transmissions using any suitable protocol (TCP, UDP, RDP etc) the angle views being predetermined in the client and the server so that there is no transmission of data back to the client. A predetermined Multi View Decision Algorithm is used having a default value (for example five views) and one such algorithm has the following format (although other algorithms could be developed and used):

Step 1

Subtract max resolution from the min resolution. In our example max resolution (640×480), and min resolution (176×144).Thus, the result from the subtraction ((640−176)&(480−144)) will be (464,336).

The 5 views are produced in the following way.

Each view is produced by adding to the min resolution (176×144), a percentage of the difference produced in step 1 (464,336).

The percentages will normally be (View1=100%, View2->75%, View3->50%, View4->25%, View5->0%). Of course, similar percentages could be applied too.

Thus, for each view, the following coordinates are produced.

View1 (640,480)
X=176+464=640.
Y=144+336=480.
View2 (524,396)
X=176+(0.75*464)=524.
Y=144+(0.75*336)=396.
View3 (408,312)
X=176+(0.50*464)=408.
Y=144+(0.50*336)=312.
View4 (292,228)
X=176+(0.25*464)=292.
Y=144+(0.25*336)=228.
View5 (176,144)
X=176+0=176.
Y=144+0=144.

After the completion of this process, 5 views are produced with the coordinates above.

A similar Diagram to FIG. 3 could describe the possible views, but five views should be drawn.

On the other side, “Client” application is also aware of this “algorithm”, thus each view should represent a percentage of the difference between the max and min resolution (100%, 75%, 50%, 25%, 0%). In this way, it is not necessary for the Client to be aware of the max and min coordinates of the streaming video, thus 1-way Client/Server interaction is feasible, speeding up the process of changing “angle-views”.

Moreover, the Server 1 acquires the maximum and minimum resolution, in order to perform the steps described above. Usually, the maximum resolution is the one provided by the video capture card (camera) 2, and the minimum is the one provided by the streaming application(usually 176×144 for mobile video). The “Multi-view decision algorithm” process should begin and finish, when the Server application 9 is first initiated.

Five “angle-views” are displayed on the Client's device.

After one “View” is picked, a message containing the identified “angle-view” is produced and sent to Server.

Server will pick that view and stream the content, according to this one in the same way as shown in FIG. 8 but having five angle views available for streaming.

An adapted client device is shown in FIG. 2 showing controls to enable the viewer to change the angle view to be displayed. A primary view screen 20 is provided on which the selected video stream is displayed. In this case the screen comprises a 176 by 144 pixel screen. A secondary screen 21 is also provided this having a low definition for enabling a display 22 to show the proportion and position of the actual video being displayed on the main screen 20. Thus the position of the box 22 within the screen 21 shows the position of the image relative to the original full size reference frame. The smaller screen 21 may be touch sensitive to enable the viewer to make an instant selection of the position to which the streamed video is to be moved to be selected.

Alternatively, selection keys 23-27 may be used to move the image either in accordance with the angle view philosophy outlined above or on a pixel by pixel basis where sufficient bandwidth exists between the client and the server to enable significant data packets to be transmitted. The key 27 is intended to allow the selection of the centre view to be shown on the display screen 20. If a fixed number of angle views are in use then the screen display may be stepped left, right, up or down in dependence upon the number of frames available.

Where video streaming of file content is provided a set of video control keys 28-32 are provided these being respectively stop function 28, reverse 29, play 30, fast forward 31 and pause 32 providing the appropriate control information to control the video display either locally where video is downloaded and stored in the device 7 or to be sent as control packets to the server 1.

An alternative control method of selecting fixed angle views is provided by selection keys 33-37 and for completeness a local volume control arrangement 38 is shown. An information display screen 39 which may carry alphanumeric text description relating to the video displayed may also be present and a further status screen 40 displaying for example signal strength for mobile telephony reception.

Further description of view selection is described hereinafter with reference first to FIG. 10. Thus using the arrow keys 33-37 and starting with the five angle views originally discussed above, these being View 1 (640×480) pixels, View 2 (524,396) View 3 (408, 312) View 4 (292, 228) and view 5 (176×144 pixels). In FIG. 10 we see view 5 (176×144 pixels) (rectangle 22) in comparison with the full frame 21 of 640×480 pixels. This may also be shown as a rectangle within the display 21 of FIG. 2 so that a user is aware of the proportion of available video capture being displayed on the main display screen 20.

The user may now select any one of the angle views to be transmitted, for example operating key 33 will produce a signal packet requesting angle view 1 from the server 1, The fully compressed display (FIG. 3) will be transmitted for display in the display area 20 while the screen 21 will show that the complete view is currently displayed.

Angle view 2 is selected by operating key 34, view 3 by key 35, view 4 by key 36 and the view first discussed (view 5) by key 37. It will be appreciated that more or less than five keys may be provided or, if display screen 20 is of the touch sensitive kind, a virtual key set could be displayed overlaid with the video so that touching the screen in an appropriate position results in the angle view request being transmitted and the required change in the transmissions from the server 1. It will also be realised that the proportion of the smaller screen 21 occupied by the rectangle 22 will also change to reflect the angle view currently displayed. This adjustment may be made by internal programming of the device 7 or could be transmitted with the data packets 18 from the server 1.

Having considered centred angle views in the above we will now consider how the user can view angle views centred at a differing point from the centre of the picture. The five views available still have the same compression ratios so that angle view 5 (176×144 pixels), shown centred in FIG. 10 relative to the full video frame (640×480) is used to describe the way in which the viewer may move across the picture or up/down.

Consider again FIG. 2 with FIGS. 10 to 12 and assume that the user operates the left arrow key 26. This will result in a network data packet being sent by the client to the server 1. The packet may include both the “left move” instruction and either a percentage of screen to move derived for example from the length of time for which the user operates the key 26 or possibly a “number of pixels” to move. The server 1 calculates the number of pixels to be moved and shifts the angle view in the left direction for as many pixels as necessary unless or until the left edge of the angle view reaches the extreme left edge of the full video frame. The return data packets now comprise the compressed video for angle view 5 at the new position while the rectangle 22 in the smaller viewing screen may also show the revised approximate position. Once centred in the new position keys 33 to 37 may be used to change the amount of the full frame being received by the client.

Key 23 may be used to indicate a move in the up direction, key 24 in the right direction and key 25 a move downwards. Each of these causes the client program to transmit an appropriate data packet and the server derives a view to be transmitted by moving accordingly to the limit of the full video frame in any direction. If the user operates key 27 this is used to return the view to the centre position as originally transmitted using the selected compression (angle views 1 to 5) last selected by the use of keys 33-37.

Now considering the virtual window display 21 of FIG. 2, the virtual window can be used to enable the user to move fast to another position and also gives the user the ability to determine where and how much of the full video frame is being displayed on the main display 20. If it is assumed that the smaller display has maximum dimensions of 12 pixels by 10 pixels (which could be an overlay in a corner of the main display as an alternative), each view will have the following percentage representations of the virtual screen, view 1=100%, view 2=80%, view 3=60%, view 4=40% and view 5=20%.

Thus by multiplying these percentages by the dimensions of the virtual window we have the following dimensions for the displayed rectangle 22:

View1 (12,10)
X=12*1=12.
Y=10*1=10.
View2 (10,8)
X=12*0.8=10
Y=10*0.8=8
View3 (7,6)
X=12*0.6=7
Y=10*0.6=6
View4 (5,4)
X=12*0.4=5
Y=10*0.4=4
View5 (2,2)
X=12*0.2=2
Y=10*0.2=2

Thus the inner rectangle 22 (probably a white representation within a black display) is drawn using the dimensions above so in the following examples the dimensions referenced above are used. The virtual window thus works in the following manner. If view 5 is selected then rectangle 22 (2 pixels×2 pixels) and screen 21 (12 pixels by 10 pixels) will have those dimensions and the virtual window will be black except for the smaller rectangle 22 which will be white. This is represented in FIG. 2 and also in FIGS. 10 to 12. Now if the virtual window is touch sensitive and the user presses the upper left corner as indicated by the dot 41 in FIG. 11 then the display is required to move as shown in FIG. 12 from the centred position to the upper left corner of the full frame (0,0 defining the top left corner of the frame).

Thus in the client, each pixel is considered as a unit and the client calculates how many units it is necessary to move in the left and up directions. From FIG. 11 it may be seen that the current position may be defined as (5,4) being the position of the top left corner of the rectangle 22, the white box. Thus to move to (0,0) it is necessary to move five pixels left and four pixels up. The difference in units between the black box and the white box is calculated, in this case being five units in the horizontal direction and four units in the vertical direction.

Accordingly as we are required to move by a percentage of the screen from the current position we may calculate that the left and up movements are 100% from the current position by taking the number of pixels to move (from the small screen) divided by the number of pixels difference between the current position and the new position. The result is that the move is 100% to move in the white box to black box gap so that the network message to be transmitted contains a left 100, up 100 instruction, the number always representing a ratio.

The server translates the message move left 100% move up 100% and activates the following procedure:

Taking in to account that, from FIG. 12, the angle view is view 5 (176×144 pixels) and the full video frame is 640 by 480 pixels it is necessary to calculate the relative position of the upper left corner of the angle view 5 window. The centre of the full size window, represented by the white dot in FIG. 12 is at 640/2=320 in the “x” dimension and at 480/2=240 in the “y” dimension (320,240). The position of the centre dot in angle view 5 relative to the upper left corner is 176/2=88 in the x dimension and 144/2=72 in the y direction. Thus for the upper left corner to move to (0,0) the centre dot must move by 320−88=232 in the left direction (x dimension) and by 240−72=168 in the up direction (y dimension). Thus the move relative to the current position is 232 pixels left and 168 pixels up thus moving the view from the centre position to the top left position shown shaded in FIG. 12. Accordingly the new angle view 5 is transmitted from the server 1 to the client device.

It will be appreciated that for example if the user selects a position left in the second (vertical) pixel row of the virtual screen the transmitted data packet would contain left 80 this being a move of four pixels in the left direction of the virtual window divided by the five pixels of the virtual window difference. Similar calculations are applied by the client in respect of other moves.

It will be appreciated that to move back from the new position (0,0) to the original position (232, 168), for example if the user now activates the centre of the virtual window, the transmitted move would be right 42 (5 pixels move with 12 pixels difference=5/12=approximately 42%) and down 40 (4 pixels move with 10 pixels remaining=4/10=40%).

Turning back to FIG. 8, where a file content is being used to provide a transmission to a smaller viewing client, a down-sampling algorithm is required Assuming a transmission frame size of 176 by 144 pixels the video to be transmitted has to be down sampled from whatever the size of the filter to 176 by 144 pixels.

The process starts with a loop of divide by two down sampling until the video cannot be further divided by two. Factors are calculated and then the final down-sampling occurs. Thus assume an input video having “M” by “N” pixels and output frame size of 176 by 144 pixels first step is to divide M by 176, the respective horizontal (X) frame dimensions giving X=M/176. X is now divided by 2 and if X is less than one after the division the width and height factors are calculated and sampling of the video using these factors gives a video in 176×144 format.

The down sampling is applied in YUV file format, before and after the application of the algorithm. Thus the Y component (640×480) is down sampled to the 176×144 Y component while the U and V components (320×240) are correspondingly down-sampled to 88×72. The entire process of the down sampling algorithm is as follows

Step 1:

Calculate Hfactor, Wfactor
   Hfactor=Width/176, where Width refers to horizontal direction (640 in our example)
   Wfactor=Height/144, where Height refers to vertical direction (480 in our example)
   Step 2:
Calculate X factor:
   X=Hfactor/2
   Step 3:
Check if X≧1
If Yes Go to Step 4 else Go to Step 6
   Step 4:
Down-sample by dividing by 4:
For Y component the formula below is used:
   Y′[i*Width/4+j/2]=((Y[i*Width+j]+Y[i*Width+j+1]+Y[(i+1)*Width+j]+Y[(i+1)*Width+j+1])/4)
Where Y′=Y component after the conversion,
Y=Y component before the conversion,
0≦i<Height, i=0,2,4,6 . . . etc
0≦j<Width, j=0,2,4,6 . . . etc
For U,V component use the formula below:
   U′[i*Width/2/4+j/2]=((U[i*Width/2+j]+U[i*Width/2+j+1]+U[(i+1)*Width/2+j]+U[(i+1)*Width/2+j+1])/4)
Where U′=either U or V component after the conversion,
U=either U or V component before the conversion,
0≦i<Height/2, i=0,2,4,6 . . . etc
0≦j<Width/2, j=0,2,4,6 . . . etc
   Step 5:
   Height=Height/2
   Width=Width/2
   X=X/2
Go to step 3:
   Step 6:
Calculate Height factor(Hcoe) and Width factor(Vcoe):
   Hcoe=Width/176
   Vcoe=Height/144
   Step 7:
This step is performed only if Width≠176, Height≠144.
Accordingly, this step corrects for input pictures where the sizes are not an even multiple of 176×144.
“Down-sample” by Width/Vcoe, and, Height/Hcoe:
For Y component the formula used is:
   Y′[i*176+j]=((Hcoe*Y[(i*Vcoe)*Width+(j*Hcoe)]+Y[(i*Vcoe*Width)+(j*Hcoe+1)])/2/(1+Hcoe)+(Vcoe*Y[(i*Vcoe+1)*Width+(j*Hcoe)]+Y[(i*Vcoe+1)*Width+(j*Hcoe+1)])/2/(1+Vcoe))
Where Y′=Y component after the conversion,
Y=Y component before the conversion,
0≦i<144, i=0,1,2,3 . . . etc
0≦j<176, j=0,1,2,3 . . . etc
For U,V components the formula used is:
   U′[i*88+j]=((Hcoe*U[(i*Vcoe)*Width/2+(j*Hcoe)]+U[(i*Vcoe*Width/2)+(j*Hcoe+1)])/2/(1+Hcoe)+(Vcoe*U[(i*Vcoe+1)*Width/2+(j*Hcoe)]+U[(i*Vcoe+1)*Width/2+(j*Hcoe+1)])/2/(1+Vcoe))
Where U′=either U or V component after the conversion,
U=either U or V component before the conversion,
0≦i<72, i=0,1,2,3 . . . etc
0≦j<88, j=0,1,2,3 . . . etc
End of process.

It will be appreciated that other algorithms could be developed the algorithm above being given for example only.

Referring now to FIG. 13, for pre-recorded content the multi-view decision algorithm referred to above may be applied first to produce as many compressed bit streams as there are angle views, the multi view decision switching mechanism determining which bit stream to transmit. Thus the Video Capture Source (2,4) supplies the full frame images to the multi view decision algorithm 14 to produce angle views 121, 131, 141 as hereinbefore described with reference to FIG. 8. Here, however each angle view is fed to a respective codec 171, 172, 173 to produce a respective bit stream 181, 182, 183. This method is particularly appropriate to pre-recorded video content.

Referring also to FIG. 14, the three bit streams are provided to the angle view switch 151, controlled as before by incoming data packets 16 from the client by way of the network. The appropriate bit stream is then passed to the codec 17 which converts to the appropriate transmission protocol for streaming in data packets 18 for display at the client device.

The present invention is particularly suited to remotely controlling an angle view to provide a selectable image or image proportion from a remote video source such as a camera or file store for display on a small screen and transmission for example by way of IP and mobile communications networks. The application of the invention to video surveillance, video conferencing and video streaming for example enables the user to decide in what detail to view and permits effective virtual zooming of the transmitted frame controlled from the remote client without the need to physically adjust camera settings for example.

In video surveillance it is possible to view a complete scene and then to zoom in to a part of the scene if there is activity of potential interest. More particularly as the complete camera frame may be stored in a digital data store it is possible to review detailed areas on a remote screen by stepping back to the stored image and moving the angle view about the stored frame.

1. A method of streaming video signals comprising the steps of capturing and/or storing a video frame or a series of video frames each frame comprising a matrix of “m” pixels by “n” pixels, compressing the or each said m by n frame to a respective derived frame of “p” pixels by “q” pixels, where p and q are respectively substantially less than m and n, for display on a screen capable of displaying a frame of at least p pixels by q pixels, transmitting the at least one derived frame and receiving signals defining a preferred selected viewing area of less than m by n pixels, compressing the selected viewing area to a further derived frame or series of further derived frames of p pixels by q pixels and transmitting the further derived frames for display characterised in that the received signals include data defining a preferred location within the transmitted further derived frame which determines the location within the m pixel by n pixel frame from which the next further derived frame is selected.

2. A method according to claim 1 in which the received signals also define a zoom level comprising a selection of one from a plurality of offered effective zoom levels each selection defining a frame comprising at least p pixels by q pixels but not more than m pixels by n pixels.

3. A method according to claim 1 in which the received signals are used to cause movement of the transmitted frame from a current position to a new position on a pixel by pixel basis.

4. A method according to claim 1 in which the received signals are used to cause movement of the transmitted frame on a frame area selection basis.

5. A method according to claim 1 in which the frame to be transmitted is automatically selected by detecting an area of apparent activity within the major (M by N) frame and transmitting a smaller frame surrounding that area.

6. A method according to claim 1 in which received control signals are used to select one of a plurality of pre-determined frame sizes and/or viewing angles.

7. A method according to claim 6 in which the control signals are used to move from a current position to a new position within the major frame and to change the size of the viewed area whereby detailed examination of a specific area of the major frame may be achieved.

8. A method according to claim 7 in which the selection is by means of a jump function responsive to control functions to select a different frame area within the major frame in dependence upon the location of a pointer.

9. A method according to claim 7 in which the selection is by means of a scrolling function, control signals causing frame movement on a pixel by pixel basis.

10. Terminal apparatus for use with a video streaming system, the apparatus comprising a first display screen (20) for displaying transmitted frames and a second display screen (21) having selectable points to indicate the area being displayed or the area desired to be displayed and transmission means for transmitting signals defining a preferred position within a currently displayed frame from which the next transmitted frame should be derived.

11. Terminal apparatus according to claim 10 including a further display means (39) including the capability to display the co-ordinates of a current viewing frame and/or for displaying text or other information relating to the viewing frame.

12. Terminal apparatus as claimed in claim 11 in which the further display means (39) displays text in the form of a URL or similar identity of a location at which information defining viewing frames is stored.

13. Terminal apparatus as claimed in claim 10 including a low bandwidth reception path for transmitting control signals and a higher bandwidth path for receiving a selected viewing frame.

14. A server comprising a computer or file server (1) having access to a plurality of video stores (4) each of which stores video frames each of which comprises a matrix of “pixels by “n” pixels; and/or connection to a camera (2) for capturing images to be transmitted and a digital image store (3) in which such images are held as a series of video frames each frame comprising a matrix of “m” pixels by “n” pixels; the computer (1) including means (9) to compress each said m by n frame to a derived frame of “p” pixels by “q” pixels, where p and q are respectively substantially less than m and n, for display on a screen (6) capable of displaying a frame of at least p pixels by q pixels, and causing the or each frame to be transmitted, the server (1) being responsive to received signals defining a preferred selection of viewing area of less than m by n pixels, to cause compression of the selected viewing area to a derived frame or series of further derived frames of p pixels by q pixels and causing the transmission of the further derived frames for display characterised in that the server (1) is responsive to data signals defining a preferred location within an earlier transmitted frame to select the location within the m by n major frame from which the next p by q derived frame is transmitted.

15. A server as claimed in claim 14 in which images captured by the camera (2) are stored in the digital image store (3), the computer (1) being responsive to control signals received from terminal apparatus (6,7) to move from a current position to a new position within a stored major (m×n) frame and to compress a selected area at the new position so that movement through the viewed area may be performed by the user at a specific instant in time if live action viewing indicates a view of interest potentially beyond or partially beyond a current viewing frame.

16. A server as claimed in claim 14 in which the computer (1) runs a plurality of instances of a selection and compression program (9) to enable respective transmissions to different users to occur.

17. A server as claimed in claim 16 in which each instance of the selection and compression program provides a selection from a camera source (2) or stored images from one of said video stores (4).

18. A server as claimed in claim 14 in which the digitised image from the camera (2) or video store (4) (major frame) is pre-selected and divided in to a plurality of frames each of which is simultaneously available to switch means (15) responsive to customer data input (16) to select which of said frames is to be transmitted.

19. A server as claimed in claim 18 in which the selected digitised image passes through a codec (17) to provide a packaged bit stream for transmission to a requesting customer.

20. A server as claimed in claim 18 in which each of the plurality of frames is converted to a respective bit stream ready for transmission to a requesting customer a switch (15) selecting, in response to customer data input (16), the one of the bit streams to be transmitted.

21. A server as claimed in claim 14 in which the computer is responsive to customer input signalling defining selection of a part frame to be viewed from a major frame, the server (1) responding to a customer data packet requesting a transmission by transmitting a compressed version of the major frame (12) or a pre-selected area (13,14) from the major frame and responds to subsequent customer data signals defining a preferred location of viewing frame to cause transmission of a bit stream defining a viewing frame at the preferred location.
